(19) United States
(12) Patent Application Publication
(10) Pub. No.: US 2021/0289267 A1
(43) Pub. Date: Sep. 16, 2021

(54) DISPLAY APPARATUS AND METHOD FOR DISPLAYING THEREOF

(71) Applicant: SAMSUNG ELECTRONICS CO., LTD., Suwon-si (KR)

(72) Inventors: Yuiyoon LEE, Suwon-si (KR); Hyunjun SONG, Suwon-si (KR)

(73) Assignee: SAMSUNG ELECTRONICS CO., LTD., Suwon-si (KR)

(21) Appl. No.: 17/154,476

(22) Filed: Jan. 21, 2021

(30) Foreign Application Priority Data
Mar. 11, 2020 (KR) 10-2020-0030399

(51) Int. Cl. H04N 21/485; G06K 9/00; H04N 21/431; H04N 21/44; G06F 3/0488

(52) U.S. Cl. CPC H04N 21/4858; G06K 9/00355; G06K 9/00228; G06F 2203/04805; H04N 21/44008; G06F 3/04886; H04N 21/4316

(57) ABSTRACT

A display apparatus includes a communicator, a display, and a processor. The processor is configured to identify a sign language image region of an input image of content received from the communicator, generate an output image in which the sign language image region is magnified, and control the display to display the output image.

### CROSS-REFERENCE TO RELATED APPLICATION(S)

This application is based on and claims priority under 35 U.S.C. § 119 to Korean Patent Application No. 10-2020-0030399, filed on Mar. 11, 2020 in the Korean Intellectual Property Office, the disclosure of which is incorporated by reference herein in its entirety.

### BACKGROUND

### 1. Field

The disclosure relates to a display apparatus and a method for displaying thereof. More particularly, the disclosure relates to a display apparatus capable of adjusting a sign language image included in an image, and a method for displaying thereof

### 2. Description of Related Art

A display apparatus refers to an apparatus which displays image signals provided from the outside. Recently, even the hearing-impaired can easily view content by transmitting broadcast images including sign language images.

According to the related art, it was difficult for the hearing-impaired to check sign language with a sign language image in that a small sign language image was displayed on one side of the image in order not to cover a broadcast content as much as possible.

A smart sign language broadcasting service has been recently provided a sign language image separately using an additional IP network, but the service requires an additional IP line, requiring maintenance costs, development of a dedicated platform, or the like.

Therefore, a method for the hearing-impaired to easily check a sign language image in an image without using an additional IP line was required.

### SUMMARY

Provided are a display apparatus capable of adjusting a sign language image included in an image, and a method for displaying thereof

Additional aspects will be set forth in part in the description which follows and, in part, will be apparent from the description, or may be learned by practice of the presented embodiments.

In accordance with an aspect of the dislcosure, a display apparatus includes a communicator, a display, and a processor configured to identify a sign language image region of an input image from content received from the communicator, generate an output image in which the identified sign language image area is magnified, and control the display to display the generated output image.

The processor may be configured to identify a location of a person whose face and hand are identified in the content, and identify a region including the identified face and hand as a sign language image region.

The processor may be configured to identify a sign language image region using a pre-learned classifier based on Haar Cascade feature.

The processor may be configured to identify a sign language image region in a predetermined region of the input image.

The processor may be configured to magnify the identified sign language image region by a predetermined ratio, and generate an output image having both the magnified sign language image and the input image.

The processor may be configured to generate an output image in which at least a part of the magnified sign language image is overlaid on the input image.

The processor may be configured to generate an output image in which the magnified sign language image and the input image are spaced apart from each other.

The processor may be configured to receive information on a magnification ratio and display position, and generate an output image based on the received information.

The processor may be configured to identify the sign language image region when a predetermined event being occurred, and generate an output image in which the identified sign language image region is magnified while playing the content.

The processor may be configured to identify the sign language image region by a unit of a predetermined period, and maintain generation of the magnified output image when the sign language image region being identified.

The processor may be configured to generate an output image in which the sign language image region is magnified when the sign language image region being identified, and generate an input image corresponding to the content as an output image when the sign language image region being not identified.

In accordance with an aspect of the disclosure, a method for displaying a display apparatus includes receiving content, identifying a sign language image region of an input image of the received content, generating an output image in which the identified sign language image region is magnified, and displaying the generated output image.

The identifying may include identifying a location of a person whose face and hand are identified in the content, and identifying a region including the identified face and hand as a sign language image region.

The identifying may include identifying a sign language image region in a predetermined region of the input image.

The generating the output image may include magnifying the identified sign language image region by a predetermined ratio, and generating an output image having both the magnified sign language image and the input image.

The generating the output image may include generating an output image in which at least a part of the magnified sign language image is overlaid on the input image.

The generating the output image may include generating an output image in which the magnified sign language image and the input image are spaced apart from each other.

The generating the output image may include receiving information on a magnification ratio and display position, and generating an output image based on the received information.

The identifying may include identifying the sign language image region when a predetermined event being occurred, and wherein the generating the output image includes generating an output image in which the identified sign language image region is magnified while playing the content.

In accordance with an aspect of the disclosure, a non-transitory computer-readable recording medium including a program for executing a method for displaying, the method includes identifying a sign language image region of an image of content, generating an output image in which the identified sign language image region is magnified, and outputting the generated output image.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating a configuration of a display apparatus according to an embodiment;

FIG. 2 is a block diagram illustrating a detailed configuration of a display apparatus according to an embodiment;

FIGS. 3 and 4 are views illustrating various examples of various output images that can be displayed on a display of FIG. 1;

FIGS. 5 and 6 are views illustrating a pre-learned classifier according to an embodiment; and

FIG. 7 is a flowchart illustrating a method for displaying according to an embodiment.

### DETAILED DESCRIPTION

Hereinafter, the disclosure will be described in detail with reference to the accompanying drawings.

The terms used in example embodiments will be briefly explained, and example embodiments will be described in greater detail with reference to the accompanying drawings.

Terms used in the disclosure are selected as general terminologies currently widely used in consideration of the configuration and functions of the disclosure, but can be different depending on intention of those skilled in the art, a precedent, appearance of new technologies, and the like. Further, in specific cases, terms may be arbitrarily selected. In this case, the meaning of the terms will be described in the description of the corresponding embodiments. Accordingly, the terms used in the description should not necessarily be construed as simple names of the terms, but be defined based on meanings of the terms and overall contents of the disclosure.

The example embodiments may vary, and may be provided in different example embodiments. Various example embodiments will be described with reference to accompanying drawings. However, this does not necessarily limit the scope of the exemplary embodiments to a specific embodiment form. Instead, modifications, equivalents and replacements included in the disclosed concept and technical scope of this specification may be employed. While describing exemplary embodiments, if it is determined that the specific description regarding a known technology obscures the gist of the disclosure, the specific description is omitted.

Singular forms are intended to include plural forms unless the context clearly indicates otherwise. In the present application, the terms “include” and “comprise” designate the presence of features, numbers, steps, operations, components, elements, or a combination thereof that are written in the specification, but do not exclude the presence or possibility of addition of one or more other features, numbers, steps, operations, components, elements, or a combination thereof

The term at least one of A and/or B may designate either “A” or “B” or “A and B”.

The expression “1”, “2”, “first”, or “second” as used herein may modify a variety of elements, irrespective of order and/or importance thereof, and only to distinguish one element from another. Accordingly, without limiting the corresponding elements.

When an element (e.g., a first element) is “operatively or communicatively coupled with/to” or “connected to” another element (e.g., a second element), an element may be directly coupled with another element or may be coupled through the other element (e.g., a third element).

In the disclosure, a ‘module’ or a ‘unit’ performs at least one function or operation and may be implemented by hardware or software or a combination of the hardware and the software. In addition, a plurality of ‘modules’ or a plurality of ‘units’ may be integrated into at least one module and may be at least one processor except for ‘modules’ or ‘units’ that should be realized in a specific hardware. Also, the term “user” may refer to a person who uses an electronic apparatus or an apparatus (e.g., an artificial intelligence (AI) electronic apparatus) that uses the electronic apparatus.

The example embodiments of the disclosure will be described in greater detail below in a manner that will be understood by one of ordinary skill in the art. However, exemplary embodiments may be realized in a variety of different configurations, and not limited to descriptions provided herein. Also, well-known functions or constructions are not described in detail since they would obscure the invention with unnecessary detail.

Hereinafter, exemplary embodiments will be described in greater detail with reference to the accompanying drawings.

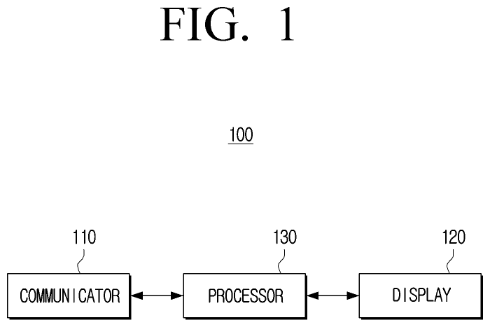

FIG. 1 is a block diagram briefly illustrating a configuration of a display apparatus, according to an embodiment.

Referring to FIG. 1, the display apparatus 100 may include a communicator 110, a display 120, and a processor 130. The display apparatus 100 may be a TV, a monitor, or the like.

The communicator 110 may include a circuitry, and transmit and receive information with an external device. The communicator 110 may include a broadcast receiver 111, a Wi-Fi module (not shown), a Bluetooth module (not shown), a local area network (LAN) module, a wireless communication module (not shown), or the like. Here, each communication module may be implemented in the form of at least one hardware chip.

The communication methods described above, wireless communication modules may include at least one communication chip that performs communication according to various wireless communication standards such as ZigBee, Ethernet, universal serial bus (USB), mobile industry processor interface camera serial interface (MIPI CSP), 3rd generation (3G), 3rd generation partnership project (3GPP), long term evolution (LTE), LTE advanced (LTE-A), 4th generation (4G), 5th generation (5G), or the like. However, this is only an example, and the communicator 110 may use at least one communication module among various communication modules.

The communicator 110 may receive content. The content may be content such as a photo, a video, or the like.

The display 120 displays an image. The display 120 may be implemented as various types of displays such as a liquid crystal display (LCD), a plasma display panel (PDP), organic light emitting diodes (OLED), quantum dot light-emitting diodes (QLED), or the like. When configured as an LCD, the display 120 may include a driving circuit, a backlight unit, and the like which may be implemented in forms such as an a-si TFT, a low temperature poly silicon (LTPS) TFT, an organic TFT (OTFT), and the like. The display 120 may be a touch screen including a touch sensor.

When configured as the LCD, the display 120 includes a backlight. In this regard, the backlight is a point light source that includes a plurality of light sources, and supports local dimming.

The light source constituting the backlight may be composed of a cold cathode fluorescent lamp (CCFL) or a light emitting diode (LED). Hereinafter, the backlight is configured with an LED and an LED driving circuit. However, at the time of implementation, the backlight may be a feature other than the LED.

The processor 130 controls overall operations of the display apparatus 100. For example, the processor 130 may control overall operations of the display apparatus 100 by executing at least one pre-stored instruction.

The processor 130 may be composed of a single device such as a central processing unit (CPU), micro processing unit (MCU), controller, System on Chip (SoC), large scale integration (LSI), application-specific integrated circuit (ASIC), a field programmable gate array (FPGA), and an application processor (AP), or may be composed of a combination of a plurality of devices such as a CPU, a graphics processing unit (GPU), or the like.

When receiving content through the communicator 110, the processor 130 may control the display 120 to display the received content.

In this case, the processor 130 may identify whether a magnification function of a sign language image is required. When the sign language image is included in the content, it is a function of magnifying and displaying the sign language image included in an image without receiving additional resources.

For this operation, the processor 130 may identify that the magnification function of the sign language image is required if the user has activated a sign language magnification function option, or if the user commands an execution of the sign language magnification function.

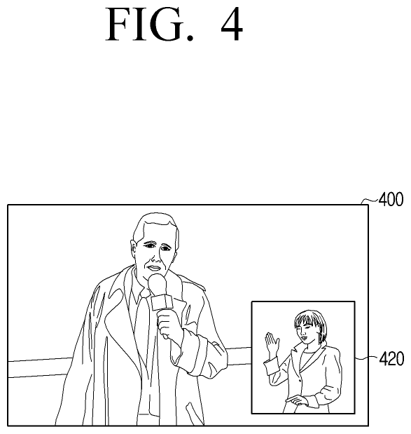

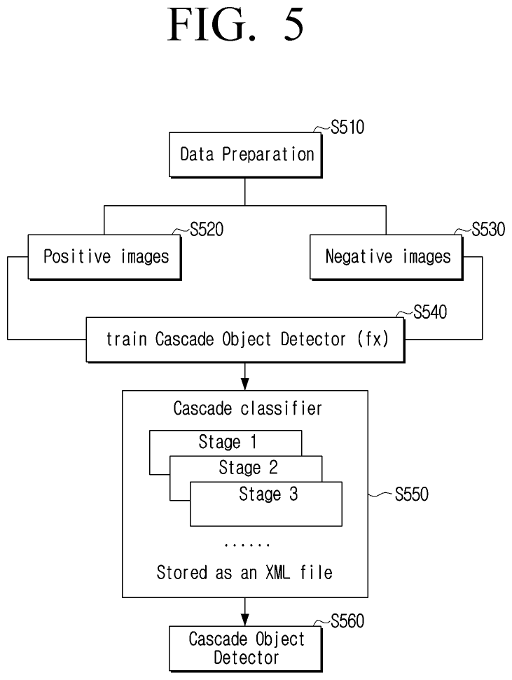

When the sign language image magnification function is required, the processor 130 may identify whether a sign language image is included in content. For example, since the sign language image in a broadcast image is generally disposed at a lower right of a screen, the processor 130 may identify whether the sign language image is included by detecting a human face and hand in the corresponding region. A method for detecting the sign language image will be described below with reference to FIGS. 4 and 5.

Meanwhile, during implementation, whether or not the sign language image is included may be performed as a direct detecting operation of the sign language image as described above, and whether the sign language image is included by using meta data information indicating whether a caption broadcast is included, whether a sign language broadcast is displayed, or the like.

If a sign language image is included, the processor 130 may identify a region of the sign language image within an image of the content. For example, the processor 130 may identify a position of a person whose face and hand are identified within an image of the content using image recognition technology. Additionally, the processor 130 may also identify a body to which the face and hand are connected.

In this case, for faster identification, the processor 130 may perform the identification operation described above only in a partial region rather than the entire image. For example, as described above, since the sign language image is generally disposed on the lower right of a screen, the identification operation may be performed with a limitation of such position. The processor 130 may detect a sign language image region using a pre-learned classifier (e.g., a classifier based on Haar Cascade feature).

Meanwhile, when a plurality of regions (i.e., a plurality of people) are detected in an image, the processor 130 may determine a region in which a person is continuously detected in a plurality of time intervals as a sign language image region.

The processor 130 may identify a region including the identified face and hand as a sign language image region. For example, a rectangular region having a predetermined size based on a center of the face and the body to which the hand is connected may be identified as a sign language image region. The predetermined size is a size that may include a region where the face and the hand are displayed, and the size may be adjusted by the user's manipulation. In addition, during implementation, not only a square but also various other shapes (circular shape, etc.) may be used.

Meanwhile, this identification operation may be periodically performed during content playback (e.g., based on a unit of a time period), and may be performed only when a predetermined time point or event occurs. For example, when a sign language image is displayed, since the sign language image is displayed at a fixed position, there is no need to repeatedly detect the sign language image region. Accordingly, the processor 130 may detect an operation of detecting whether a sign language image exists or an operation of detecting a position of the sign language image, when the content being played is variable, when there is a user request, or when a content that is predicted to contain a sign language image is required.

Meanwhile, during implementation, it may be performed in real time when the image is output, and the processor 130 may display a magnified image when a sign language is detected in a detection process performed in real time, and may not display the magnified image if the sign language image is not detected when the sign language is not detected. The real time may be a thing to detect whether a sign language exists for each frame constituting the image, and may be, for example, a time period such as 1 to 2 seconds, or the like, or a frame period of 20 to 100 frames.

Further, the processor 130 may magnify the identified sign language image region, and generate an output image by synthesizing the magnified image region and an input image corresponding to the content. For example, the processor 130 may magnify the identified sign language image region and generate the output image by synthesizing the magnified image and the input image. In this case, the processor 130 may display the magnified sign language image and the input image in parallel (i.e., spaced apart from each other), or may display part or all of them to overlap.

In addition, the processor 130 may control the display 120 to display the generated output image. Meanwhile, it has been illustrated and described that the generated output image is displayed in FIG. 1, but if it is implemented in a device that does not have a display configuration such as a set-top box, or the like, and when implemented as a set-top box, the display 120 configuration may not perform by itself and other connected devices may perform.

Meanwhile, the processor 130 may control the display 120 such that only an input image corresponding to a current content is displayed when a sign language image is not detected or the content is converted to a content in which the sign language image is not detected.

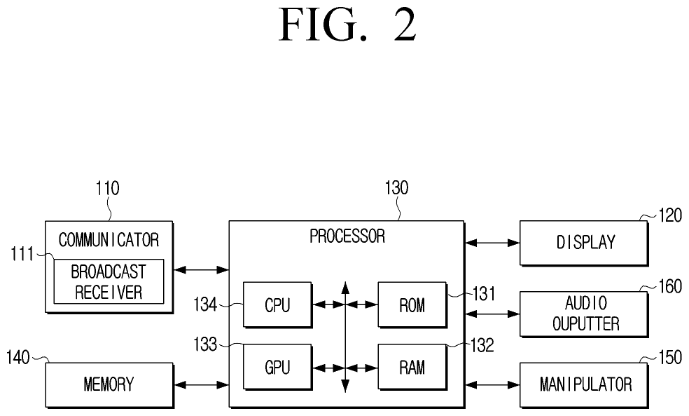

In the above, only a simple configuration of the display apparatus 100 has been described, but the display apparatus 100 may further include features illustrated in FIG. 2. A detailed description of a configuration of the display apparatus 100 is provided below with reference to FIG. 2.

FIG. 2 is a block diagram illustrating a detailed configuration of a display apparatus according to an embodiment.

Referring to FIG. 2, the display apparatus 100 according to the embodiment may include a communicator 110, a display 120, a processor 130, a memory 140, a manipulator 150, and an audio outputter 160.

Since the display 120 is the same as the configuration of FIG. 1, a redundant description is omitted.

The communicator 110 may include a broadcast receiver 111. The broadcast receiver 111 may receive a broadcasting signal in a wired or wireless manner from a broadcasting station or a satellite and demodulate the received broadcasting signal.

In addition, the broadcast receiver 111 may separate the received broadcasting signal (e.g., a transport stream signal) into a video signal, an audio signal, and an additional information signal. The broadcast receiver 111 may provide the separated video signal and/or additional information signal to the processor 130 and the audio signal to the audio outputter 160. The processor 130 may identify whether a sign language image is included in an image corresponding to the image signal by using the additional information signal in the broadcasting signal.

During implementation, the entire video signal/audio signal may be provided to the processor 130, and the signal-processed audio signal may be provided to the audio outputter 160.

At least one instruction with respect to the display apparatus 100 may be stored in the memory 140. For example, various programs (or software) for operating the display apparatus 100 may be stored in the memory 140 according to various embodiments of the disclosure.

In addition, the memory 140 may store content. For example, the memory 140 may receive and store video content compressed with video and audio from the broadcast receiver 111.

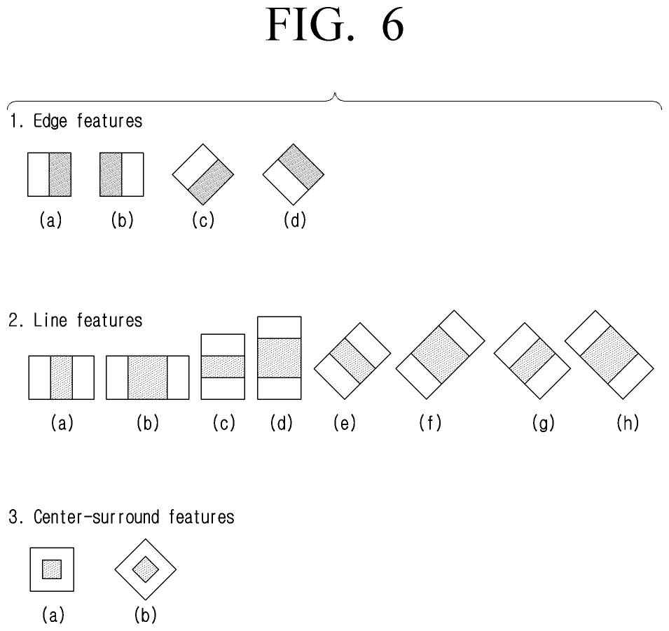

In addition, the memory 140 may store a pre-learned classifier. The pre-learned classifier is an image recognizer that detects a human body and may detect various parts of the human body in stages. The pre-learned classifier will be described later with reference to FIGS. 5 and 6. The classifier is currently learned in a device other than the display apparatus 100, and the learned result may be stored in the memory 140.

Meanwhile, the memory 140 may be implemented as a non-volatile memory (e.g., a hard disk, a solid state drive (SSD), a flash memory), a volatile memory, or the like. Meanwhile, the memory 140 may be implemented as a memory physically separated from the processor 130. In this case, the memory 140 may be implemented in a form of a memory embedded in the display apparatus 100 or may be implemented in a form of a memory that can be attached or detached to the display apparatus 100 depending on the purpose of data storage.

For example, the memory 140 may be implemented in a form of a volatile memory (e.g., dynamic random accessible memory (DRAM), static RAM (SRAM), or synchronous dynamic RAM (SDRAM)), a non-volatile memory (e.g., one time programmable ROM (OTPROM)), programmable ROM (PROM), erasable programmable ROM (EPROM), electrically erasable and programmable ROM (EEPROM), mask ROM, flash ROM, flash memory (e.g., NAND flash or NOR flash, etc.), hard drive, or solid state drive (SSD), memory card (e.g., compact flash (CF), secure digital (SD)), micro secure digital (Micro-SD), mini secure digital (Mini-SD)), xD (extreme digital), MMC (multi-media card), etc.), an external memory (e.g., USB memory) that can be connected to a USB port.

In addition, the memory 140 may be implemented as an internal memory such as a ROM (e.g., an electrically erasable programmable read-only memory (EEPROM)), a RAM included in the processor 130, or the like.

The audio outputter 160 may convert the audio signal that is output from the broadcast receiver 111 or the processor 130 into sound, and may output the sound through a speaker (not shown) or to an external device connected thereto through an external output terminal (not shown).

The manipulator 150 may include a touch screen, touch pad, key button, keypad, and the like, to allow a user manipulation of the display apparatus 100. In the embodiment, an example in which a control command is received through the manipulator 150 included in the display apparatus 100 is described, but the manipulator 150 may receive a user manipulation from an external control device, for example a remote controller.

The manipulator 150 may receive a region of a sign language image from the user, or a position and an extension ratio in which the extended sign language image is displayed.

The processor 130 controls overall operations of the display apparatus 100. Specifically, the processor 130 may control GPU 133 and the display 120 so that an image according to a control command received through the manipulator 150 is displayed.

The processor 130 may include ROM 131, RAM 132, GPU 133, and CPU 134. The ROM 131, RAM 132, CPU 134, and GPU 133 may be connected to each other through bus.

The CPU 134 may access the memory 140 and boot using the O/S stored in the memory 140. The CPU 134 may also perform various operations by using various types of programs, contents, data, and the like stored in the memory 140. Operations of the CPU 134 have been described above in connection with the processor 130 in FIG. 1, according to an embodiment.

The ROM 131 may store a set of commands for system booting. If a turn-on command is input and the power is supplied, the CPU 134 copies the O/S stored in the memory 140 into the RAM 132 according to the command stored in the ROM 131, and boots the system by executing the O/S. When the booting is completed, the CPU 134 may copy the various programs stored in the memory 140 to the RAM 132, and perform various operations by implementing the programs copied to the RAM 132.

In detail, the GPU 133 may, when booting of the display apparatus 100 is completed, generate a screen that includes various objects such as an icon, an image, a text, and the like. The GPU 133 may be configured as a separate feature such as the GPU 133, and may be configured as a System on Chip (SoC) that is combined with the CPU within the processor 130.

The GPU 133 may generate a graphic user interface (GUI) for providing to the user. Such a GUI may be an on screen display (OSD), and may be implemented as a digital signal processor (DSP).

Further, the GPU 133 may detect a sign language image. For example, the GPU 133 may detect whether the sign language image is included in the input image using a pre-learned classifier stored in the memory, and if the image is included, the GPU may detect a position of the sign language image. Such a detecting operation may be performed periodically, and may be performed only when a pre-determined event (initial content playback time, user request, etc.) occurs.

In addition, the GPU 133 may generate an output image obtained by combining the detected sign language image and the input image. For example, the GPU 133 may magnify the detected sign language image by a predetermined ratio. In this case, the GPU 133 may perform image quality correction processing on the magnified sign language image.

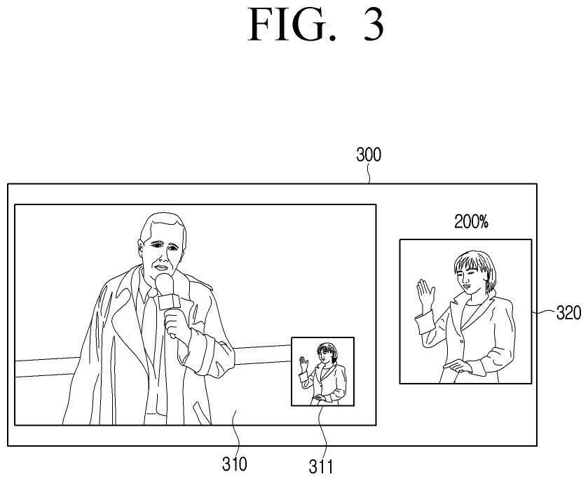

Further, the GPU 133 may generate an output image by synthesizing the magnified sign language image and a current image. Arrangement of the sign language image and the current image may be variously performed, and two types of arrangement examples will be described later with reference to FIGS. 3 and 4.

As described above, the display apparatus 100 according to the embodiment may magnify and display a sign language image region in the image, so that a user who watches the sign language image can more easily see the sign language. In addition, when the sign language image is magnified and displayed, since a separate network and resources are unnecessary, there is no need to construct additional infrastructure.

Meanwhile, in FIGS. 1 and 2, although the display is shown and described as being an essential component, it may be implemented in a set-top box form in which a displaying function during implementation is omitted. In this case, the display apparatus may be referred to as an electronic device, a smart box, a set-top box, or the like.

FIGS. 3 to 4 are views illustrating various examples of various output images that can be displayed on a display of FIG. 1.

Specifically, FIG. 3 is a view illustrating an example of a screen displaying an input image and a sign language image separately.

Referring to FIG. 3, a user interface window 300 includes a first area 310 and a second area 320.

The first area 310 is an area in which an input image is displayed as it is. The input image includes a sign language image, and generally, the sign language image is arranged in a small size on the screen as shown.

The second area 320 is an area in which the included sign language area is magnified and displayed. As described above, in the disclosure, the sign language area included in the content is magnified and displayed such that a viewer who needs a sign language image may more easily identify the sign language through the sign language image.

Meanwhile, in the illustrated example, the input image and the sign language image are shown to be spaced apart from each other. In this case, there may be blanks in upper and lower regions. Therefore, in order to minimize the blank area, it is possible to remove the blank area by overlaying and displaying the magnified sign language image on the input image. This will be described later with reference to FIG. 4.

FIG. 4 is a view illustrating an example of a screen displaying a magnified sign language area on an input image.

Referring to FIG. 4, a user interface window 400 includes a first area 410 and a second area 420 disposed in the first area 410.

The first area 410 is an area displaying an input image.

The second area 420 is an area in which a sign language area included in the input image is magnified and displayed. As described above, since the second area 420 is displayed by being overlaid on the first area, the blank area may be minimized.

Meanwhile, during implementation, the user may adjust a position and size of the second area, and may display the sign language area with a position and size adjusted by the user.

FIGS. 5 and 6 are views illustrating a pre-learned classifier according to an embodiment.

FIG. 5 is a view illustrating a learning method for a classifier used to identify a sign language image in the disclosure.

For example, the classifier used in the disclosure may be Haar feature-based cascade classifiers. The classifier is an effective object detecting method, and is a machine learning classifier that trains cascade function by simultaneously using an image with an object to be detected (i.e., positive image) and an image without an object to be detected (i.e., negative image).

In the disclosure, an image required to classify a sign language image may be prepared (S510), and learning may be performed using each of an image including the sign language image (S520) and an image not including the sign language image (S540), respectively.

The learning described above may perform an operation of extracting features, and Haar features may be used when extracting the features. The feature is a value obtained by subtracting a sum of pixel values in a white square from a sum of pixel values in a black square area. An example of the Haar feature is shown in FIG. 6.

Meanwhile, in order to calculate many features, all possible sizes and positions for each kernel to be applied to an image should be considered. Meanwhile, an integral image may be used to speed up classification learning.

Meanwhile, some of all the calculated features are suitable for use, while others are not. For example, it is required to classify a feature suitable for classification among several features through learning.

For example, for each feature, the highest threshold value which will classify whether there is a face on the image or not (i.e., whether it is positive or negative). Through this process, a final classifier may be found.

The classifier S550 learned through the process above may sequentially search for features within an image, and, for example, may find a sign language image region by searching for a face, a hand, and a body in the image.

When the classifier is learned, a sign language image for the input image may be detected using the learned classifier (S560).

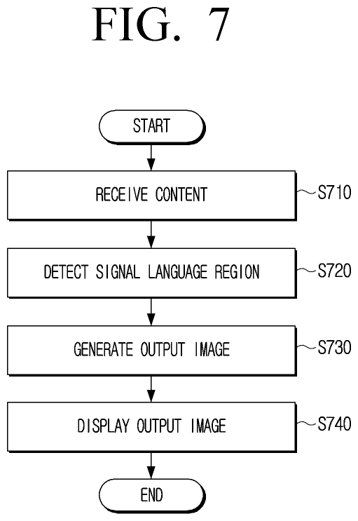

FIG. 7 is a flowchart illustrating a method for displaying according to an embodiment.

Referring to FIG. 7, content is received (S710). The content may be broadcast content received as a broadcasting signal, may be Internet content received through an Internet network, or may be pre-stored content.

A sign language image region is identified from an input image of the received content (S720). For example, a position of a person whose face and hand are identified in the content may be identified, and a region including the identified face and hand may be identified as a sign language image region. In this case, an identification operation may be performed only on a predetermined region (e.g., lower right region of the image), not the entire region of the received content.

An output image in which the identified sign language image region is magnified is generated (S730). For example, the identified sign language image region may be magnified by a predetermined ratio, and an output image including the magnified sign language image and an input image corresponding to the content may be generated. In this case, the output image may be an image in which at least a part of the magnified sign language image is overlaid on the input image, and may be an image in which the magnified sign language image and the input image are spaced apart from each other.

The generated output image is displayed (S740). Meanwhile, during implementation, the displaying operation may be performed in another electronic device. In this case, the displaying operation may be replaced with outputting to the other device.

As described above, the data processing method according to the embodiment, since error correction may be performed without separately converting real-valued data into binary data, or whether it is identical to the existing data may be identified, more precise error correction or authentication may be performed on the real-valued data.

Since detailed operations of each step have been described above, detailed descriptions are omitted.

The methods according to the above-described example embodiments may be realized as software or applications that may be installed in the existing electronic apparatus.

Further, the methods according to the above-described example embodiments may be realized by upgrading the software or hardware of the existing electronic apparatus.

The above-described example embodiments may be executed through an embedded server in the electronic apparatus or through an external server outside the electronic apparatus.

The various example embodiments described above may be implemented as an S/W program including an instruction stored on machine-readable (e.g., computer-readable) storage media. The machine is an apparatus which is capable of calling a stored instruction from the storage medium and operating according to the called instruction, and may include an electronic apparatus (e.g., an electronic apparatus A) according to the above-described example embodiments. When the instruction is executed by a processor, the processor may perform a function corresponding to the instruction directly or using other components under the control of the processor. The command may include a code generated or executed by a compiler or an interpreter. A machine-readable storage medium may be provided in the form of a non-transitory storage medium. Herein, the term “non-transitory” only denotes that a storage medium does not include a signal but is tangible, and does not distinguish the case where a data is semi-permanently stored in a storage medium from the case where a data is temporarily stored in a storage medium.

According to an embodiment, the methods according to various embodiments described above may be provided as a part of a computer program product. The computer program product may be traded between a seller and a buyer. The computer program product may be distributed in a form of the machine-readable storage media (e.g., compact disc read only memory (CD-ROM) or distributed online through an application store (e.g., PlayStore™) In a case of the online distribution, at least a portion of the computer program product may be at least temporarily stored or provisionally generated on the storage media, such as a manufacturer's server, the application store's server, or a memory in a relay server.

Various exemplary embodiments described above may be embodied in a recording medium that may be read by a computer or a similar apparatus to the computer by using software, hardware, or a combination thereof. In some cases, the embodiments described herein may be implemented by the processor itself. In a software configuration, various embodiments described in the specification such as a procedure and a function may be embodied as separate software modules. The software modules may respectively perform one or more functions and operations described in the present specification.

Computer instructions for performing processing operation of an apparatus according to various embodiments may be stored on a non-transitory readable medium. The computer instructions stored in the non-transitory computer-readable medium may cause a particular device to perform processing operations on the device according to the various embodiments described above when executed by the processor of the particular device.

The non-transitory computer readable recording medium refers to a medium that stores data and that can be read by devices. For example, the non-transitory computer-readable medium may be CD, DVD, a hard disc, Blu-ray disc, USB, a memory card, ROM, or the like.

The respective components (e.g., module or program) according to the various example embodiments may include a single entity or a plurality of entities, and some of the corresponding sub-components described above may be omitted, or another sub-component may be further added to the various example embodiments. Alternatively or additionally, some components (e.g., module or program) may be combined to form a single entity which performs the same or similar functions as the corresponding elements before being combined. Operations performed by a module, a program module, or other component, according to various exemplary embodiments, may be sequential, parallel, or both, executed iteratively or heuristically, or at least some operations may be performed in a different order, omitted, or other operations may be added.

While certain embodiments have been particularly shown and described with reference to the drawings, embodiments are provided for the purposes of illustration and it will be understood by one of ordinary skill in the art that various modifications and equivalent other embodiments may be made from the disclosure. Accordingly, the true technical scope of the disclosure is defined by the technical spirit of the appended claims.

What is claimed is:

1. A display apparatus comprising:
a communicator;
a display; and
a processor configured to:
identify a sign language image region of an input image of content received from the communicator,
generate an output image in which the sign language image region is magnified, and
control the display to display the output image.

2. The display apparatus of claim 1, wherein the processor is configured to identify a location of a person whose face and hand are identified in the content, and identify a region including the face and the hand as the sign language image region.

3. The display apparatus of claim 2, wherein the processor is configured to identify the sign language image region using a pre-learned classifier based on Haar Cascade feature.

4. The display apparatus of claim 1, wherein the processor is configured to identify the sign language image region in a predetermined region of the input image.

5. The display apparatus of claim 1, wherein the processor is configured to magnify the sign language image region by a predetermined ratio, and generate the output image having both the magnified sign language image and the input image.

6. The display apparatus of claim 5, wherein the processor is configured to generate the output image in which at least a part of the magnified sign language image is overlaid on the input image.

7. The display apparatus of claim 5, wherein the processor is configured to generate the output image in which the magnified sign language image and the input image are spaced apart from each other.

8. The display apparatus of claim 5, wherein the processor is configured to receive information on a magnification ratio and a display position, and generate the output image based on the received information.

9. The display apparatus of claim 1, wherein the processor is configured to the sign language image region based on a predetermined event, and generate the output image in which the sign language image region is magnified while playing the content.

10. The display apparatus of claim 1, wherein the processor is configured to identify the sign language image region at a predetermined periods, and maintain generation of the magnified sign language image based on the sign language image region being identified.

11. The display apparatus of claim 1, wherein the processor is configured to generate the output image in which the sign language image region is magnified based on the sign language image region being identified, and generate the output image as the input image based on the sign language image region not being identified.

12. A method of a display apparatus, the method comprising:
receiving content;
identifying a sign language image region of an input image of the content;
generating an output image in which the sign language image region is magnified; and
displaying the output image.

13. The method of claim 12, wherein the identifying comprises:
identifying a location of a person whose face and hand are identified in the content; and
identifying a region including the face and the hand as the sign language image region.

14. The method of claim 12, wherein the identifying comprises identifying the sign language image region in a predetermined region of the input image.

15. The method of claim 12, wherein the generating the output image comprises:
magnifying the sign language image region by a predetermined ratio; and
generating the output image having both the magnified sign language image and the input image.

16. The method of claim 15, wherein the generating the output image comprises generating the output image in which at least a part of the magnified sign language image is overlaid on the input image.

17. The method of claim 15, wherein the generating the output image comprises generating the output image in which the magnified sign language image and the input image are spaced apart from each other.

18. The method of claim 15, wherein the generating the output image comprises:
receiving information on a magnification ratio and a display position; and
generating the output image based on the received information.

19. The method of claim 12, wherein the identifying comprises identifying the sign language image region based on a predetermined event, and
wherein the generating the output image comprises generating the output image in which the sign language image region is magnified while playing the content.

20. A non-transitory computer-readable recording medium including a program which, when executed by a processor, causes the processor to execute a displaying method including:
identifying a sign language image region of an image of content;
generating an output image in which the sign language image region is magnified; and
outputting the output image.
